(19) United States
(12) Patent Application Publication
(10) Pub. No.: US 2026/0291726 A1
(43) Pub. Date: Sep. 24, 2026

(54) LOCKING AND UNLOCKING A COMMUNICATION INTERFACE OF AN ELECTRONIC DEVICE FOR A MOTOR VEHICLE

(71) Applicant: CONNAUGHT ELECTRONICS LTD., Tuam (IE)

(72) Inventor: Thomas Mohr, Bietigheim-Bissingen (DE)

(73) Assignee: CONNAUGHT ELECTRONICS LTD., Tuam (IE)

(21) Appl. No.: 19/472,960

(22) PCT Filed: Apr. 2, 2024
(86) PCT No.: PCT/EP2024/058909

§ 371 Date: Oct. 6, 2025

(30) Foreign Application Priority Data
Apr. 6, 2023 (DE) 10 2023 108 877.7

(51) Int. Cl. H04L 9/08; G06F 8/61

(52) U.S. Cl. CPC H04L 9/088; G06F 8/61

(57) ABSTRACT

Described is a method for locking a communication interface of an electronic device for a motor vehicle. A first identifier is determined which characterizes a hardware component of a computing unit of a production line in which the electronic device was produced or a software component of the computing unit. A second identifier is obtained which characterizes the electronic device. A first input value for a specified key derivation function is generated by the computing unit on the basis of the first identifier, and a second input value for the key derivation function is generated on the basis of the second identifier. A key is generated by the computing unit on the basis of the first input value and the second input value using the key derivation function, and the communication interface is locked using the key.

The invention relates to a method for locking a communication interface of an electronic device for a motor vehicle, and to a corresponding method for unlocking a communication interface of an electronic device for a motor vehicle. The invention also relates to data processing devices and to a computer program product.

Electronic devices for motor vehicles, such as control units or sensors, can have communication interfaces for different purposes. Where appropriate, it may be desirable for safety reasons or to avoid misuse to disable such communication interfaces as soon as the electronic device is used for normal operation after production. This can be the case, among other things, with troubleshooting interfaces, also known as debugging interfaces, such as JTAG interfaces. Such communication interfaces are used during production, for example, for software installation of the electronic device and/or for testing software of the electronic device or for troubleshooting. They are not usually required during normal operation and can therefore be locked, in particular by password protection. However, it may also be necessary after production to access the electronic device via the communication interface, for example for troubleshooting or for changing the software stored on the electronic device or for storing or reading other data. Therefore, in order to gain access, a user may need to enter the correct password.

Document US 2017/0090909 A 1 describes a method for securely writing patch code to a memory of an SoC. A JTAG interface can be used to check the functionality of the SoC. The JTAG interface can be unlocked by entering an interface password by the SoC manufacturer. In a password-locked state, values stored in components of the SoC and/or any other functionality of the SoC cannot be modified via the JTAG interface.

It is an object of the present invention to provide secure access protection for a communication interface of an electronic device for a motor vehicle.

This object is achieved by the respective subject matter of the independent claims. Advantageous refinements and preferred embodiments are the subject matter of the dependent claims.

The invention is based on the idea of locking the communication interface using a key, also referred to in simplified terms as a password, which is derived on the one hand from an identifier assigned to the individual electronic device, but on the other hand from at least one identifier assigned to a hardware component or a software component of a computing unit, which comes from a production line in which the electronic device was produced. The first-mentioned part-specific identifier and the last-mentioned production line-specific identifier enable the key to be reconstructed retrospectively. Two-factor authentication is also implemented in order to increase security.

According to one aspect of the invention, a method, for example a computer-implemented method, for locking a communication interface of an electronic device for a motor vehicle is specified. In this case, a first identifier is determined, which characterizes a hardware component of a computing unit of a production line in which the electronic device has been produced, or a software component of the computing unit. The first identifier is determined in particular by means of the computing unit. A second identifier is obtained, in particular by the computing unit, which characterizes the electronic device, in particular uniquely characterizes it. A first input value for a predetermined key derivation function is generated by means of the computing unit on the basis of the first identifier, and a second input value for the key derivation function is generated on the basis of the second identifier. A key, in particular a cryptographic key, is generated by means of the computing unit on the basis of the first input value and the second input value using the key derivation function. The communication interface is locked using the key, preferably automatically, in particular by means of the computing unit.

The first identifier is such that the characterized individual hardware or software component can be clearly determined from the knowledge of the first identifier. For example, it could be a serial number or the like. This applies analogously to the second identifier, so that if the second identifier is known, the individual electronic device it characterizes can be uniquely determined. This can also be a serial number or the like, for example.

Depending on the embodiment, the first input value can be identical to the first identifier or the first input value is derived from the first identifier according to a predetermined rule. In various embodiments, it is also possible to determine, in addition to the first identifier, one or more further first identifiers of the software or hardware component or one or more further hardware or software components of the computing unit and to derive or calculate the first input value on the basis of the first identifier and the further identifiers.

The same applies analogously to the second identifier or the second input value. The second input value can therefore be identical to the second identifier or be derived therefrom, optionally on the basis of the second identifier and one or more further second identifiers, which characterize the electronic device.

If, in addition to the first identifier, further first identifiers are used for further hardware or software components, then the corresponding further hardware or software component can be uniquely determined from the further first identifiers. In using one or more further second identifiers, these can also enable a unique determination of the electronic device, depending on the embodiment. However, this is not necessarily the case, so that the further second identifiers, in contrast to the second identifier, can also be ambiguous. For example, the further second identifiers can include a model identifier, a production period, a batch number, a production site, and so on relating to the electronic device.

The key derivation function is designed, for example, to uniquely derive a corresponding key from two separate input values, in the present case the first input value and the second input value, thus in this case it is a function of two variables. Accordingly, identical input values always result in the same key. Depending on the embodiment, the two input values can also be linked or combined by computation in order to generate a common input value and the key derivation function generates the key from the common input value, thus in this case it is a function of one variable.

By locking the communication interface by means of the key, the communication interface is thus placed in a locked or encrypted state in which a user from outside the electronic device cannot access the electronic device via the communication interface. The communication interface can be unlocked, that is, put into an unlocked or decrypted state, by entering the key used to lock it via the communication interface or a further interface of the electronic device.

The communication interface is in particular a communication interface for wired communication between an external computing unit and a processor or a memory element or another component of the electronic device. The communication interface includes in particular a hardware interface and/or a software interface.

The method according to the invention thus achieves a high degree of security with regard to unauthorized or undesirable access to the electronic device via the communication interface, by using the first and second identifiers as two mutually independent factors for generating the key. By using the second identifier, a unique association of the generated key with the individual electronic device is achieved. The content of the first identifier is independent of this and, above all, cannot be easily identified by a party potentially accessing the communication interface without authorization. In addition, however, if the method according to the invention is known, the key can be reliably reconstructed should the communication interface have to be unlocked.

Furthermore, in the method according to the invention, the first identifier is used, which is based on a hardware component or software component of that computing unit of the key generation, which is also used for deriving the input values for the key derivation function and for generating the key based thereon. In this way, the security can be further increased.

The computing unit is part of the production line in which the electronic device was produced. This means in particular that steps for the production of the electronic device have been carried out by means of the computing unit prior to carrying out the method according to the invention, for example, for configuring the electronic device with software and/or for testing the software.

A computing unit can be understood as meaning, in particular, a data processing apparatus which contains a processing circuit. The computing unit can therefore process data in particular for carrying out computing operations. Optionally, these also include operations for performing indexed accesses to a data structure, for example a look-up table (LUT).

The computing unit can in particular contain one or more computers, one or more microcontrollers, and/or one or more integrated circuits, for example one or more application-specific integrated circuits (ASIC), one or more field-programmable gate arrays (FPGA), and/or one or more systems-on-a-chip (SoC). The computing unit can also contain one or more processors, for example one or more microprocessors, one or more central processing units (CPU), one or more graphics processing units (GPU), and/or one or more signal processors, in particular one or more digital signal processors (DSP). The computing unit can also contain a physical or virtual group of computers or other types of the mentioned units.

In various exemplary embodiments, the computing unit contains one or more hardware and/or software interfaces and/or one or more storage units.

A storage unit can be configured as a volatile data memory, for example as a dynamic random access memory (DRAM) or a static random access memory (SRAM), or as a non-volatile data memory, for example as a read-only memory (ROM), as a programmable read-only memory (PROM), as an erasable programmable read-only memory (EPROM), as an electrically erasable programmable read-only memory (EEPROM), as a flash memory or flash EEPROM, as a ferroelectric random access memory (FRAM), as a magnetoresistive random-access memory (MRAM), or as a phase-change random-access memory (PCRAM).

According to at least one embodiment of the method for locking a communication interface, the electronic device is programmed and/or tested at least in part by means of the computing unit before the determination of the first identifier and/or a software installation on the electronic device is carried out by means of the computing unit before the determination of the first identifier and/or troubleshooting of the electronic device is carried out by means of the computing unit.

The mentioned steps can be seen as part of the production of the electronic device. These can be carried out at least in part via the communication interface. In this case, the computing unit is thus connected via the communication interface to the electronic device and can then remain connected thereto, for example, in order to automatically use the key for locking the communication interface.

According to at least one embodiment, the communication interface is a troubleshooting interface of the electronic device.

In the case of such troubleshooting interfaces, which are also referred to as debugging interfaces, the use of the invention is particularly advantageous, since these may be used in warranty cases or in the event of errors in the field, in order to be able to access this again after the actual production of the electronic device.

For example, the troubleshooting interface is standardized according to the industry standard IEEE1149.1, commonly referred to as JTAG (joint test action group).

According to at least one embodiment, the second identifier is determined on the basis of a serial number of the electronic device.

For example, the second identifier can be identical to the serial number of the electronic device, or the second identifier can be determined on the basis of the serial number together with additional part-specific information.

On the one hand, the serial number of the electronic device is suitable for uniquely determining the electronic device, and on the other hand, the serial number is generally electronic or analog, for example in the form of character strings or an optically or electronically readable code, present on the electronic device even after the actual production has been completed.

According to at least one embodiment, the first identifier is determined on the basis of a serial number of the hardware component of the computing unit and/or on the basis of a serial number of the software component of the computing unit.

The hardware component can be, for example, a main circuit board, also referred to as a motherboard, the computing unit or a data memory, for example an SSD drive or an HDD drive, of the computing unit. The software component can be, for example, an operating system or a firmware, such as BIOS firmware, of the computing unit.

For example, the serial number of the hardware component or software component can be read and determined automatically by the computing unit itself, so that the security of the method can be further increased.

According to at least one embodiment, a further first identifier is determined which characterizes a further hardware component of the computing unit or a further software component of the computing unit, in particular by means of the computing unit. The first input value is generated on the basis of the first identifier and the further first identifier.

For example, in further embodiments, more than just one further first identifier can be determined and correspondingly treated in an analogous manner. The first identifier and the further first identifier(s) can be concatenated with each other, or linked to each other via a logical operation, such as an XOR operation, or any other rule, in order to generate the first input value. In this way, the security of the key is further improved.

According to at least one embodiment, the key is generated with a bit length of at least 32 bit or at least 64 bit. A high degree of security can thus be achieved.

According to at least one embodiment, the electronic device is a sensor for the motor vehicle or an electronic control unit for the motor vehicle.

The electronic control unit, ECU, can also be configured as a zone control unit, ZCU, or a domain control unit, DCU.

The sensor can be, for example, an environment sensor, for example a camera, a lidar system, a radar system or an ultrasonic sensor system, or a further sensor for the motor vehicle, for example, a steering angle sensor, an acceleration sensor, an inertial measurement unit, IMU, and so on.

Electronic control units and sensors for motor vehicles are partly highly safety-relevant components that must be reliably protected against unwanted or unauthorized access and for which authorized access must still be possible after production. The invention has a particularly advantageous effect in this regard.

According to at least one embodiment of the method, at least one historical data set is provided on a storage device. Each historical data set of at least one historical data set contains corresponding historical identification information for the hardware component or the software component of the computing unit and a production period associated with the historical identification information. Most recent historical identification information of a most recent historical data set of the at least one historical data set is read from the storage device, in particular by means of the computing unit. The most recent historical identification information is associated with a most recent production period. A most recent historical first input value is determined on the basis of the most recent historical identification information.

A hash value is generated on the basis of the first input value, in particular by means of the computing unit, using a predefined hash function. A further hash value is generated on the basis of the most recent historical first input value, in particular by means of the computing unit, using the hash function. It is checked, in particular by means of the computing unit, whether the hash value matches the further hash value. If the hash value does not match the further hash value, a further historical data set is stored on the storage device, in particular by means of the computing unit. The further historical data set contains the first input value and a production period associated with the first input value, or the further historical data set contains the first identifier and a production period associated with the first identifier.

In particular, the individual historical data sets also contain, as respective historical identification information, either a corresponding historical first input value for the key derivation function or a respective historical first identifier. In the former case, the most recent historical first input value is determined by reading it out from the corresponding most recent historical data set. In the latter case, a most recent historical first identifier is read out from the corresponding most recent historical data set and, based on this, the most recent historical first input value is determined, in particular as explained above with regard to the generation of the first input value.

The historical identification information therefore directly or indirectly characterizes a historical hardware component or historical software component of the computing unit that was present in the computing unit for the corresponding associated production period.

The most recent historical production period can be understood in such a way that no more recent production period exists in the historical data sets of at least one historical data set. The most recent historical data set is then the historical data set that contains the most recent production period, and the most recent historical identification information is that contained in the most recent historical data set.

The storage device is in particular a storage device provided externally to the computing unit, which in particular represents a secure, access-restricted environment.

If the hash value matches the additional hash value, this means that the first input value matches the most recent historical first input value, or that the first identifier matches the most recent historical first identifier. This means that the hardware component or software component of the computing unit, which is characterized by the first identifier or by the first input value, corresponds with the software component or hardware component of the computing unit, which is characterized by the most recent historical first input value or the most recent historical identifier.

Accordingly, it can be ensured that when at least one historical data set on the storage device is used to reconstruct the password for unlocking the communication interface of an electronic device, all necessary information is stored on the storage device. If this is not the case, therefore if the hash value does not match the further hash value, the method of locking the communication interface or generating the key can be interrupted until the further historical data set is stored on the storage device and the corresponding testing steps can be carried out again. The hash value then matches the further hash value when it is carried out again.

In particular, the hash value is generated independently of the most recent historical first input value or only on the basis of the first input value. Similarly, the additional hash value is generated independently of the first input value or only on the basis of the most recent historical input value.

The hash function is in particular a cryptological hash function, for example a SHA-2 function, in particular a SHA-256 function.

For application cases or application situations which can result in the method and which are not explicitly described here, provision can be made, according to the method, for an error message and/or a request to input user feedback to be output and/or for a default setting and/or a predetermined initial state to be set.

According to a further aspect of the invention, a method for unlocking a communication interface of an electronic device for a motor vehicle is specified, wherein the electronic device has been locked by means of a method according to the invention for locking a communication interface. According to the method for unlocking the communication interface, the at least one historical data set is provided on the storage device, in particular the external storage device, wherein each historical data set of at the least one historical data set contains the corresponding historical identification information and the production period associated with the historical identification information. A device identifier which characterizes the electronic device with the communication interface to be unlocked is determined and, on the basis of the device identifier, a production period of the electronic device with the communication interface to be unlocked is determined, in particular by means of a further computing unit.

On the basis of the thus determined production period, one of the historical data sets is selected, in particular that which corresponds to the production period determined on the basis of the device identifier, in particular by means of the further computing unit. On the basis of the historical identification information of the selected historical data set, a historical first input value for the key derivation function is generated, in particular by means of the further computing unit. On the basis of the device identifier, a current second input value for the key derivation function is generated, in particular by means of the further computing unit. Using the key derivation function, a key is reconstructed on the basis of the historical first input value and the current second input value, in particular by means of the further computing unit. The communication interface is unlocked using the reconstructed key, in particular by means of the further computing unit.

With regard to the historical identification information, the historical first input values and their relation to the historical identifiers, reference is made to the method described above for locking the communication interface.

In this way, a possibility of unlocking the communication interface is specified, in which the key itself does not have to be stored, but can be reliably reconstructed for all production periods and accordingly all relevant electronic devices.

For application cases or application situations which can result in the method and which are not explicitly described here, provision can be made, according to the method, for an error message and/or a request to input user feedback to be output and/or for a default setting and/or a predetermined initial state to be set.

According to a further aspect of the invention, a data processing device is specified which has a computing unit which is configured to carry out a method according to the invention for locking a communication interface of an electronic device for a motor vehicle.

According to a further aspect of the invention, a further data processing device having a further computing unit is specified, wherein the further computing unit is configured to carry out a method according to the invention for unlocking a communication interface of an electronic device for a motor vehicle.

According to a further aspect of the invention, a computer program having commands is specified, wherein the commands, when executed by a data processing device, in particular a data processing device according to the invention, cause the data processing device to carry out a method according to the invention for locking a communication interface of an electronic device for a motor vehicle.

The commands can be present as program code, for example. The program code can, for example, be provided as binary code or an assembler and/or as source code of a programming language, for example C, and/or as program script, for example Python.

According to a further aspect of the invention, a further computer program having further commands is specified, wherein the further commands, when executed by a further data processing device, in particular a further data processing device according to the invention, cause the further data processing device to carry out a method according to the invention for unlocking a communication interface of an electronic device for a motor vehicle.

The further commands can be present as program code, for example. The program code can, for example, be provided as binary code or an assembler and/or as source code of a programming language, for example C, and/or as program script, for example Python.

According to a further aspect of the invention, a computer-readable storage medium is specified, the latter storing a computer program according to the invention or a further computer program according to the invention.

The computer program, the further computer program, and the computer-readable storage medium can each be regarded as a computer program product having the commands or the further commands.

Further features of the invention emerge from the claims, the figures, and the description of the figures. The features and combinations of features mentioned above in the description and the features and combinations of features mentioned below in the description of the figures and/or shown in the figures can be included in the invention not only in the combination specified in each case, but also in other combinations. In particular, embodiments and combinations of features that do not have all the features of an originally worded claim can also be included in the invention. Furthermore, embodiments and combinations of features that go beyond or differ from the combinations of features set out in the back-references of the claims can be included in the invention.

The invention is explained in more detail below on the basis of specific exemplary embodiments and associated schematic drawings. In the figures, identical or functionally identical elements may be provided with the same reference signs. The description of identical or functionally identical elements may not necessarily be repeated with respect to different figures.

In the figures, shown schematically:

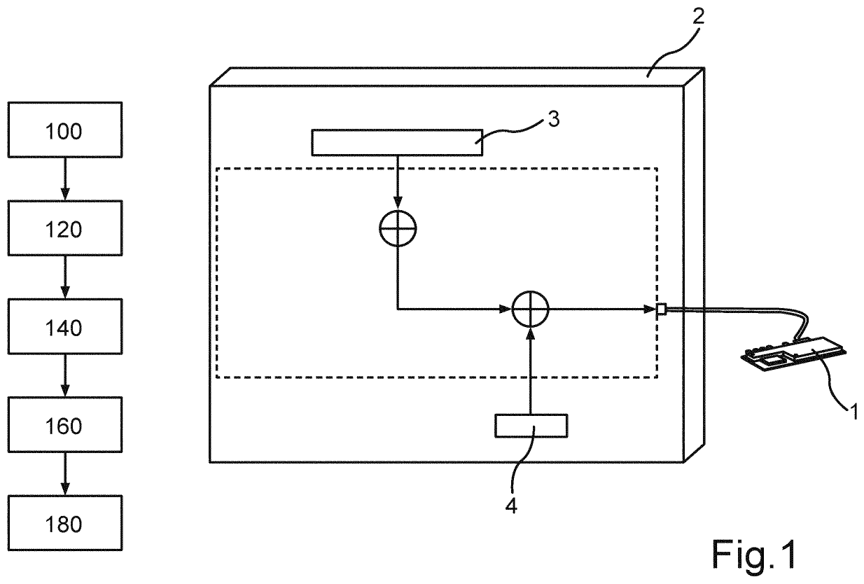

FIG. 1 shows a flowchart of an exemplary embodiment of a method according to the invention for locking a communication interface of an electronic device for a motor vehicle;

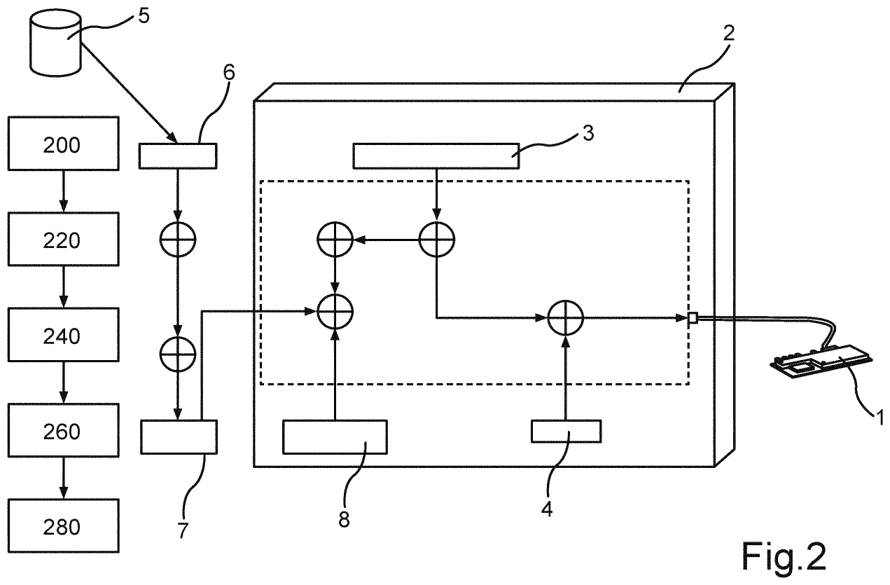

FIG. 2 shows a flowchart of a further exemplary embodiment of a method according to the invention for locking a communication interface of an electronic device for a motor vehicle; and

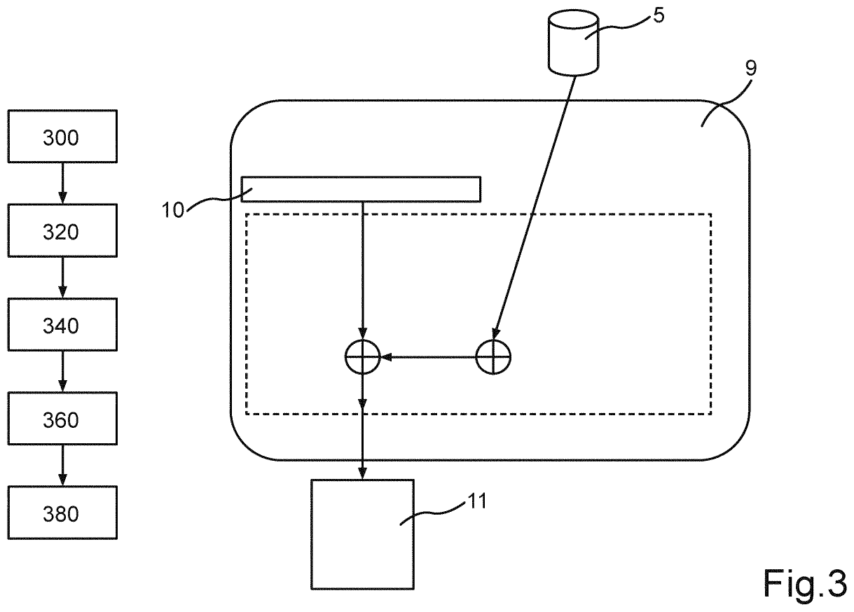

FIG. 3 shows a flowchart of a further exemplary embodiment of a method according to the invention for unlocking a communication interface of an electronic device for a motor vehicle.

FIG. 1 shows a schematic flowchart of an exemplary embodiment of a method according to the invention for locking a communication interface of an electronic device 1, for example, a control unit or a sensor, for a motor vehicle.

The electronic device 1 was produced in a production line which has a computing unit 2, for example a programming station. By means of the computing unit 2, for example, a software installation and/or troubleshooting of the electronic device 1 was carried out and/or the electronic device was tested by means of the computing unit 2.

The electronic device 1 has a communication interface, in particular a troubleshooting interface, for example a JTAG interface, which can be locked or unlocked by means of a cryptological key.

In step 100, a first identifier 3 is determined, in particular by means of the computing unit 2, which characterizes a hardware component, for example an SSD memory or a main circuit board, which characterizes the computing unit 2 or a software component, for example an operating system or a firmware, which characterizes the computing unit 2. For example, the first identifier 3 can be a serial number of the hardware component or the software component. Optionally, at least one further first identifier can be determined, which characterizes at least one further hardware component and/or at least one further software component of the computing unit 2.

In step 120, the computing unit 2 obtains a second identifier 4 which characterizes the electronic device 1, for example, a serial number of the electronic device 1. The computing unit 2 can automatically determine the second identifier 4, for example when this is stored electronically on the electronic device 1, or a user can provide the computing unit 2 with the second identifier by means of an input device, for example, a keyboard or an optical reader or an RFID reader. Optionally, the optical reader or the RFID reader can also be positioned such that the second identifier 4 can thus be read automatically.

In step 140, the computing unit 2 generates a first input value for a predetermined key derivation function on the basis of the first identifier 3. If the at least one further first identifier has been determined, the computing unit 2 generates the first input value on the basis of the first identifier 3 and on the basis of the at least one further first identifier. For example, the computing unit 2 can concatenate the first identifier 3 with the at least one further first identifier or link these via a logical operation, for example an XOR operation, in order to generate the first input value or convert it into the first input value via a further operation. The computing unit 2 generates a second input value for the key derivation function on the basis of the second identifier 4 In step 160, the computing unit 2 generates applies the key derivation function to the first input value and the second input value, thus generating a key. In step 180, the communication interface is locked using the key, in particular automatically by means of the computing unit 2. In particular, the computing unit 2 is connected to the communication interface or a further communication interface of the electronic device 1 for this purpose.

FIG. 2 shows a schematic flowchart of a further exemplary embodiment of a method according to the invention for locking the communication interface based on the embodiment according to FIG. 1.

First, step 100 is also carried out here. At least one historical data set is stored on a storage device 5, which is in particular provided externally to the computing unit 2. For the sake of simplicity, the following assumes that the storage device stores several such historical data sets; in the case of a single historical data set, the procedure is analogous. Each of the historical data sets contains corresponding historical identification information for the hardware component or software component of the computing unit 2 and a production period associated with the historical identification information. For different production periods, this can involve different hardware components or software components, which, however, always have the same function in the computing unit 2. It is therefore still referred to as “the” hardware component or “the” software component.

In particular, the production periods are unique, so that they can be uniquely ordered chronologically. Consequently, one of the production periods is uniquely a most recent production period. The associated historical data set is referred to as the most recent historical data set and its historical identification information is referred to as the most recent historical identification information 6. In step 200, the computing unit 2 reads the most recent historical identification information from the storage device 5.

In step 220, the computing unit 2 determines a most recent historical first input value for the key derivation function on the basis of the most recent historical identification information 6. For example, the historical identification information of the historical data sets can be the same as the first historical input value. Alternatively, the historical identification information can each contain a historical first identifier and optionally at least one further historical first identifier, analogous to that described above with regard to the first identifier and the at least one further first identifier. The most recent historical first input value is then, analogously as described above with respect to the first input value, from the historical first identifier and optionally the at least one further historical first identifier of the most recent historical identification information 6.

In step 240, the computing unit 2 generates a hash value 8 on the basis of the first input value using a predetermined hash function and in step 260, the computing unit 2 generates a further hash value 7 on the basis of the most recent historical first input value using the hash function.

In step 260, the computing unit 2 checks whether the hash value 8 matches the further hash value 7. If this is the case, steps 120 to 180 are carried out as described above.

Otherwise, in step 280 the computing unit 2 stores a further historical data set on the storage device 5, which contains the first input value and a production period associated with the first input value or which contains the first identifier and a production period associated with the first identifier. The further historical data set is then the most recent historical data set.

This allows changes in the hardware component or software component to be identified that would result in a different first input value. The locking of the communication interface can then first be canceled and an error message or warning message can be issued, for example. Steps 100 and 200 through 260 can then be repeated. Now that the hash value 8 matches the additional hash value 7, steps 120 through 180 can be executed as described above.

FIG. 3 shows a schematic flowchart of an exemplary embodiment of a method according to the invention for unlocking a communication interface of an electronic device 1, which has been locked by means of a method according to the invention as described in FIG. 1 and FIG. 2.

In step 300, a further computing unit 9 different from the computing unit 2 obtains a device identifier 10 of the electronic device 1, which corresponds to the second identifier. In step 320, the further computing unit 9 determines a production period of the electronic device 1 on the basis of the device identifier 10. In step 340, the further computing unit 9 selects the one of the historical data sets containing the production period of the electronic device 1. On the basis of the historical identification information of the selected historical data set, the further computing unit 9 generates a historical first input value for the key derivation function and, on the basis of the device identifier 10, generates a current second input value for the key derivation function, analogous to that described above with regard to the first input value and the second input value.

In step 360, the further computing unit 9 reconstructs the key 11 using the key derivation function on the basis of the historical first input value and the current second input value. In step 380, the communication interface is unlocked using the reconstructed key 11.

As described, in particular with reference to the figures, the invention enables secure access protection for a communication interface of an electronic device for a motor vehicle. In particular, part-specific keys are generated which do not need to be stored, but rather can be reconstructed if necessary.

1. A method for locking a communication interface of an electronic device for a motor vehicle, comprising:
determining a first identifier which characterizes a hardware component of a computing unit of a production line in which the electronic device was produced, or characterizes a software component of the computing unit;
determining a second identifier which characterizes the electronic device;
generating a first input value for a predetermined key derivation function by means of the computing unit on a basis of the first identifier and generating a second input value for the key derivation function on a basis of the second identifier;
generating a key by means of the computing unit on a basis of the first input value and the second input value using the key derivation function; and
locking the communication interface using the key.

2. The method as claimed in claim 1, wherein the electronic device is programmed and/or tested at least in part by means of the computing unit before determining the first identifier and/or a software installation of the electronic device is carried out by means of the computing unit and/or troubleshooting of the electronic device is carried out by means of the computing unit.

3. The method as claimed in claim 1, wherein the communication interface is a troubleshooting interface of the electronic device.

4. The method as claimed in claim 1, wherein the second identifier is determined on a basis of a serial number of the electronic device.

5. The method as claimed in claim 1, wherein the first identifier is determined on a basis of a serial number of the hardware component of the computing unit and/or on a basis of the serial number of the software component of the computing unit.

6. The method as claimed in claim 1, wherein the software component is an operating system of the computing unit or a firmware of the computing unit and/or wherein the hardware component is a main circuit board of the computing unit or a data memory of the computing unit.

7. The method as claimed in claim 1, wherein
a further first identifier is determined which characterizes a further hardware component of the computing unit or a further software component of the computing unit; and
the first input value is generated on a basis of the first identifier and the further first identifier.

8. The method as claimed in claim 1, wherein the key is generated with a bit length of at least 32 bit.

9. The method as claimed in claim 1, wherein the electronic device is a sensor for the motor vehicle or an electronic control unit for the motor vehicle.

10. The method as claimed in claim 1, comprising:
providing at least one historical data set on a storage device, wherein each historical data set of the at least one historical data set contains corresponding historical identification information for the hardware component or the software component of the computing unit and for a production period associated with the historical identification information;
reading most recent historical identification information of a most recent historical data set of the at least one historical data set from the storage device, wherein the most recent historical identification information is associated with a most recent production period;
determining a most recent historical first input value on a basis of the most recent historical identification information;
generating a hash value on a basis of the first input value using a predetermined hash function;
generating a further hash value on a basis of the most recent historical first input value using the hash function; and
if the hash value does not match the further hash value, storing a further historical data set on the storage device, which contains the first input value and a production period associated with the first input value or which contains the first identifier and a production period associated with the first identifier.

11. The method as claimed in claim 10, wherein each historical data set of the at least one historical data set contains, as respective historical identification information
a respective historical first input value for the key derivation function; or
a respective historical first identifier.

12. A method for unlocking a communication interface of an electronic device for a motor vehicle, which was locked by means of a method as claimed in claim 1, comprising:
providing at least one historical data set on a storage device, wherein each historical data set of the at least one historical data set contains corresponding historical identification information and a production period associated with the historical identification information;
determining a device identifier which characterizes the electronic device;
determining a production period of the electronic device on a basis of the device identifier;
selecting one of the historical data sets on a basis of the production period of the electronic device;
generating a historical first input value for the key derivation function on a basis of the historical identification information of the selected historical data set;
generating a current second input value for the key derivation function on a basis of the device identifier;
reconstructing a key on a basis of the historical first input value and the current second input value using the key derivation function; and
unlocking the communication interface using the reconstructed key.

13. A data processing device having a computing unit which is configured to carry out a method as claimed in claim 1.

14. A data processing device having a further computing unit, which is configured to carry out a method as claimed in claim 12.

15. A computer program product having commands which, when executed by a data processing device, cause the data processing device to carry out a method as claimed in claim 1.
